(19) United States
(12) Patent Application Publication
(10) Pub. No.: US 2005/0123018 A1
(43) Pub. Date: Jun. 9, 2005

(54) Ridge type distributed feedback semiconductor laser

(75) Inventors: Kazuhisa Takagi, Tokyo (JP); Satoshi Shirai, Tokyo (JP); Toshitaka Aoyagi, Tokyo (JP); Yasuaki Tatsuoka, Tokyo (JP); Chikara Watatani, Tokyo (JP); Yoshihiko Hanamaki, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/952,901

(22) Filed: Sep. 30, 2004

(30) Foreign Application Priority Data
Dec. 3, 2003 (JP) 2003-404391

(51) Int. Cl. H01S 3/08

(52) U.S. Cl. 372/96

(57) ABSTRACT

A distributed feedback semiconductor laser includes an n-InP substrate, an n-InGaAsP diffraction grating layer above the n-InP substrate, an AlGaInAs-MQW active layer above the diffraction grating layer and a ridge portion on the active layer. The ridge portion includes a p-InP cladding layer and a p-InGaAs contact layer. The wavelength λg corresponding to the bandgap energy of the diffraction grating layer and the oscillation wavelength λ of laser light produced by the laser satisfy the relationship
λ−150 nm<λg<λ+100 nm.

### BACKGROUND OF THE INVENTION

1. Field of the Invention

The present invention relates to a ridge type distributed feedback semiconductor laser, and more particularly to a ridge type distributed feedback semiconductor laser primarily used as a light source for optical communications devices.

2. Background Art

Ridge type distributed feedback semiconductor lasers (hereinafter referred to as ridge type DFB semiconductor lasers) have received attention for use as a light source for optical communications devices, since they exhibit a highly stable single longitudinal mode.

FIG. 4 is a cross-sectional view of a conventional ridge type DFB semiconductor laser. See, for example, T. Takiguchi et al., “High speed 1.3 μm AlGaInAs DFB-LD with λ/4-shift grating”, 2001 International Conference on Indium Phosphide and Related Materials, Conference Proceedings, 13^{th} IPRM, May 14-18, 2001, WP-03, p. 140-142. Referring to the figure, reference numeral 401 denotes an n-InP substrate; 402, an n-InP buffer layer; 403, an active layer including an AlGaInAs multiple quantum well structure; 404, a p-InP cladding layer; 405, a p-InGaAsP diffraction grating layer; 406, a p-InP cladding layer; 407, a p-InGaAsP-BDR (Band Discontinuity Reduction) layer; 408, a p-InGaAs contact layer; 409, an SiO₂ insulating film; 410, a Ti/Pt/Au anode electrode; and 411, AuGe/Ni/Ti/Pt/Ti/Pt/Au cathode electrode.

When a forward current flows from the anode electrode 410 to the cathode electrode 411, holes and electrons are injected into the active layer 403 from the anode side and the cathode side, respectively. This causes carrier population inversion within the active layer 403, producing an optical gain. As a result, the spontaneous emission light is fed back through the diffraction grating layer 405 provided adjacent the active layer 403. When the current has been increased to more than a threshold value due to the feedback, laser oscillation occurs, emitting laser light. At that time, the amount of forward current may be modulated to modulate the intensity of the laser light.

Thus, the above conventional ridge type DFB semiconductor laser is configured such that the diffraction grating layer is formed within a p-type semiconductor layer. It should be noted that in this configuration, the wavelength λg corresponding to the bandgap energy of the InGaAsP material constituting the diffraction grating layer may be set close to the laser oscillation wavelength λ to increase the coupling constant κL of the diffraction grating, which is expected to lead to laser oscillation at a reduced threshold (current) value.

However, the closer the wavelength λg to the oscillation wavelength λ, the more likely that holes accumulate within the p-InGaAsP diffraction grating layer and that electrons (which have a small effective mass) “go over” the active layer and also accumulate within the diffraction grating layer. As a result, recombination between a large number of carriers which does not contribute to the laser oscillation occurs within the diffraction grating layer, causing the problem of increased laser threshold value and reduced luminous efficiency.

### SUMMARY OF THE INVENTION

The present invention has been devised in view of the above problems. It is, therefore, an object of the present invention to provide a ridge type DFB semiconductor laser exhibiting a small laser oscillation threshold current and high luminous efficiency.

Other objects and advantages of the present invention will become apparent from the following description.

According to one aspect of the present invention, a ridge type distributed feedback semiconductor laser comprises an n-type semiconductor substrate, an n-type diffraction grating layer formed above the semiconductor substrate, an active layer formed above the diffraction grating layer and including a multiple quantum well structure, and a ridge portion formed on said active layer and including a p-type cladding layer and a p-type contact layer. A wavelength λg corresponding to bandgap energy of the diffraction grating layer and an oscillation wavelength λ of laser light satisfy the following relationship (1).
λ−150 nm<λg<λ+100 nm (1)

### BRIEF DESCRIPTION OF THE DRAWINGS

FIG. 1 is a perspective view of a ridge type distributed feedback semiconductor laser according to the present invention.

FIG. 2 is a cross-sectional view of the ridge type DFB semiconductor laser shown in FIG. 1.

FIG. 3 is a cross-sectional view of a ridge type distributed feedback semiconductor laser according to the present invention.

FIG. 4 is a cross-sectional view of a conventional ridge type distributed feedback semiconductor laser.

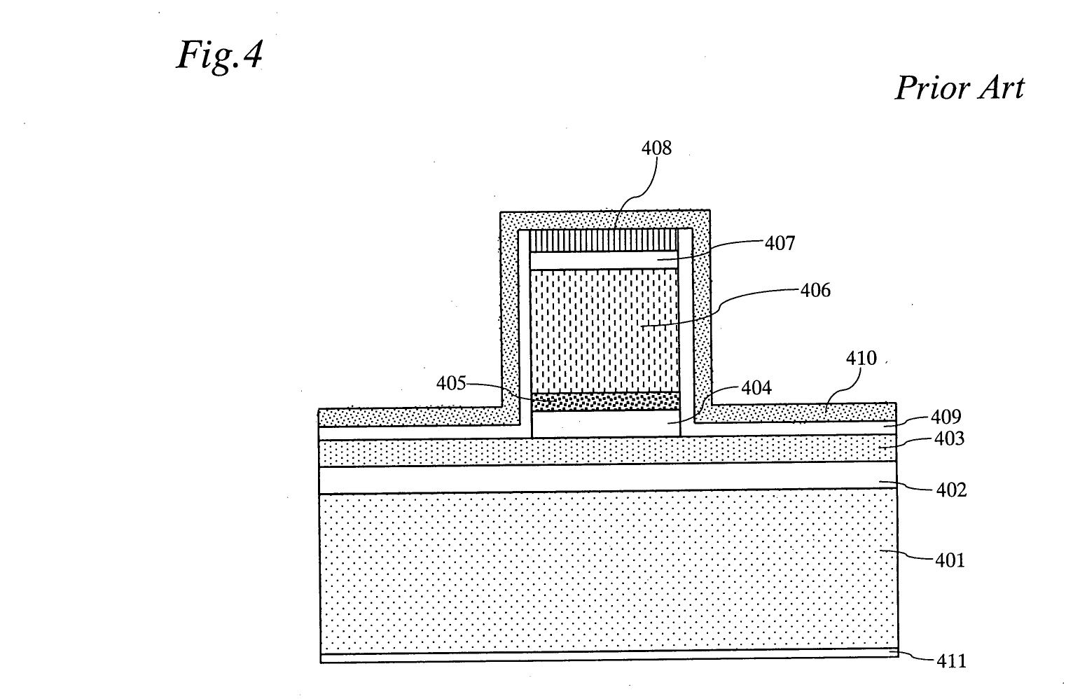

### DETAILED DESCRIPTION OF THE PREFERRED EMBODIMENTS

According to the present invention, a ridge type distributed feedback semiconductor laser comprises: an n-type semiconductor substrate; an n-type diffraction grating layer formed above the semiconductor substrate; an active layer formed above the diffraction grating layer; and a ridge portion formed on the active layer and including a p-type cladding layer and a p-type contact layer.

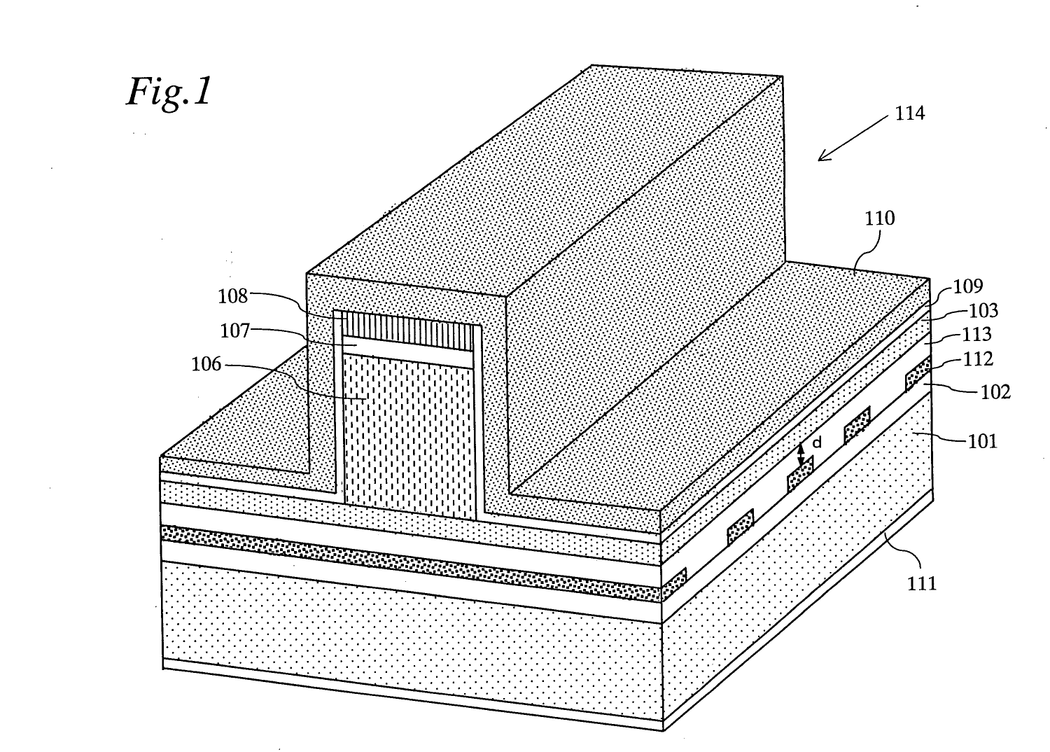

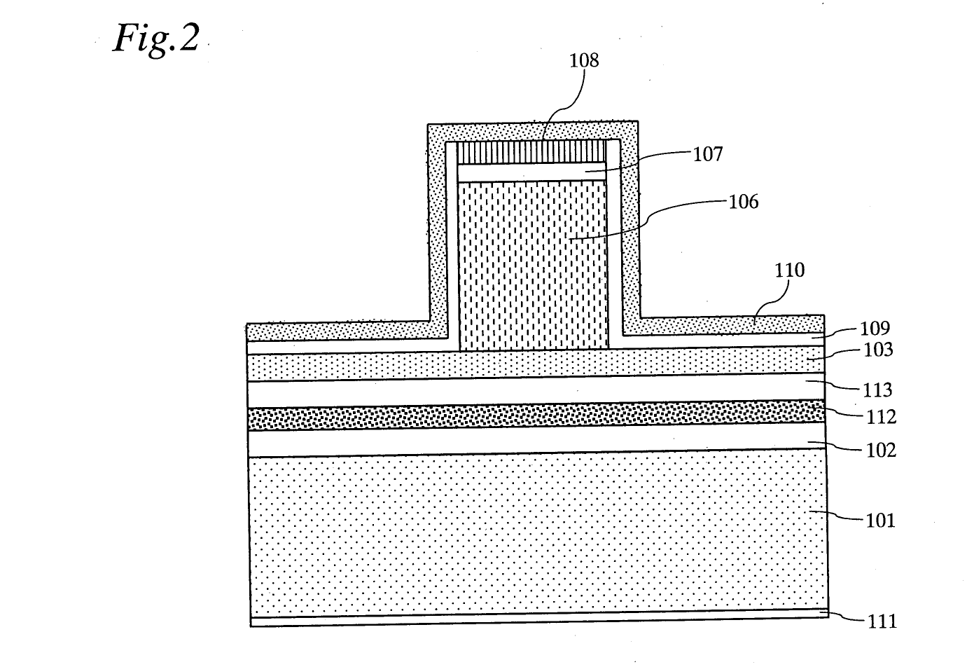

FIG. 1 is a perspective view of a ridge type distributed feedback semiconductor laser (hereinafter referred to as a ridge type DFB semiconductor laser) according to an embodiment of the present invention. FIG. 2 is a cross-sectional view of the ridge type DFB semiconductor laser shown in FIG. 1.

Referring to FIGS. 1 and 2, reference numeral 101 denotes an n-InP substrate; 102, an n-InP buffer layer; 112, an n-InGaAsP diffraction grating layer; 113, an n-InP cladding layer; 103, an active layer including an AlGaInAs multiple quantum well structure; 106, a p-InP cladding layer; 107, a p-InGaAsP-BDR (Band Discontinuity Reduction) layer; 108, a p-InGaAs contact layer; 109, an SiO₂ insulating film; 110, a Ti/Pt/Au anode electrode; and 111, an AuGe/Ni/Ti/Pt/Pt/Ti/Au cathode electrode.

It should be noted that in this specification, the n-InGaAsP diffraction grating layer 112, the Ti/Pt/Au anode electrode 110, and the AuGe/Ni/Ti/Pt/Ti/Pt/Au cathode electrode 111 are sometimes simply referred to as the diffraction grating layer 112, the anode electrode 110, and the cathode electrode 111, respectively, for simplicity.

As shown in FIG. 1, the diffraction grating layer 112 is formed to include grooves arranged at predetermined intervals. The n-InP cladding layer 113 is formed between the diffraction grating layer 112 and the active layer 103 such that the n-InP cladding layer 113 fills the grooves in the diffraction grating layer 112. With this arrangement, when a forward current flows from the anode electrode 110 to the cathode electrode 111, holes and electrons are injected into the active layer 103 from the anode side and the cathode side, respectively. This causes carrier population inversion within the active layer 103, producing an optical gain. As a result, the spontaneous emission light is fed back through the diffraction grating layer 112 provided adjacent the active layer 103. When the current has been increased to more than a threshold value due to the feedback, laser oscillation occurs, emitting laser light. At that time, the amount of forward current may be modulated to modulate the intensity of the laser light.

Let λ denote the oscillation wavelength of the laser light and λg denote the wavelength corresponding to the bandgap energy of the InGaAsP material constituting the diffraction grating layer 112. The coupling constant κL of the diffraction grating can be increased by setting the wavelength λg close to the oscillation wavelength λ. This can reduce the threshold current at which the laser light oscillation occurs. To reduce the threshold current and generate single-mode oscillation, the coupling constant κL preferably satisfies expression (2) below. In this case, the resonator length L of the laser may satisfy expression (3) below.
3≦κL≦5 (2)
200 μm≦L<300 μm (3)

The present embodiment is characterized in that the diffraction grating layer 112 is formed within an n-type semiconductor.

Holes have a larger effective mass than electrons. Therefore, ridge type DFB semiconductor lasers formed by conventional methods, in which the diffraction grating layer is formed within a p-type semiconductor, have a problem in that electrons (which have a small effective mass) “go over” the active layer and enter into the diffraction grating layer and, as a result, recombination between holes and electrons occurs. In a ridge type DFB semiconductor laser in which the diffraction grating layer is formed within an n-type semiconductor, on the other hand, holes (which have a large effective mass) are not likely to “go over” the active layer and enter the diffraction grating layer. That is, the present embodiment forms the diffraction grating layer 112 within an n-type semiconductor to reduce the recombination between holes and electrons within the diffraction grating layer 112. Therefore, few holes accumulate in the diffraction grating layer 112 even when the wavelength λg is increased to a value approximately equal to the oscillation wavelength λ. This means that the wavelength λg may be set to a value close to the oscillation wavelength λ to increase the coupling constant κL of the diffraction grating, making it possible to reduce the threshold current at which the laser oscillation occurs and thereby increase the laser light emission efficiency.

It should be noted that the wavelength λg and the oscillation wavelength λ preferably satisfy expression (4), more preferably expression (5), even more preferably expression (6), most preferably expression (7). The smaller the value of the expression “|λg−λ|”, the larger the coupling constant κL.
λ−150 nm<λg<λ+100 nm (4)
λ−100 nm<λg<λ+100 nm (5)
λ−50 nm<λg<λ+100 nm (6)
λ−25 nm<λg<λ+100 nm (7)

Furthermore, the oscillation wavelength λ of the ridge type DFB semiconductor layer of the present embodiment preferably satisfies at least one of expressions (8) and (9) below.
1.20 μm≦λ≦1.45 μm (8)
1.45 μm≦λ≦1.65 μm (9)

A description will be given below of an exemplary method for manufacturing a ridge type DFB semiconductor laser according to the present embodiment with reference to FIGS. 1 to 3.

First of all, an n-InP substrate 101 having a thickness of approximately 100 μm and a carrier concentration of 1×10¹⁸ cm⁻³˜5×10¹⁸ cm⁻³ is prepared as an n-type semiconductor substrate.

Then, an n-InP buffer layer 102 is formed on the n-InP substrate 101 by an MOCVD (Metal Organic Chemical Vapor Deposition) technique or MBE (Molecular Beam Epitaxy) technique. The film thickness of the n-InP buffer layer 102 may be set to 100 nm˜3,000 nm, and its carrier concentration may be set to 1×10¹⁸ cm⁻³˜2×10¹⁸ cm⁻³.

After forming the n-InP buffer layer 102, an n-InGaAsP diffraction grating layer 112 is formed thereon by an MOCVD technique or MBE technique. It should be noted that the n-InGaAsP diffraction grating layer 112 is an n-type diffraction grating layer of the present invention. The film thickness of the n-InGaAsP diffraction grating layer 112 may be set to 20 nm˜100 nm, and its carrier concentration may be set to 1×10¹⁸ cm⁻³˜5×10¹⁸ cm⁻³. After that, the n-InGaAsP diffraction grating layer 112 is dry-etched using a hard mask made up of, for example, an SiO₂ film. Specifically, this step etches the n-InGaAsP diffraction grating layer 112 such that the diffraction grating layer has a stripe pattern in which narrow strips and grooves are arranged at predetermined intervals.

Then, an n-InP cladding layer 113 is formed on the n-InGaAsP diffraction grating layer 112 by an MOCVD technique or MBE technique. The carrier concentration of the n-InP cladding layer 113 may be set to 1×10¹⁸ cm⁻³˜4×10¹⁹ cm⁻³. Further, the film thickness of the n-InP cladding layer 113 is set such that the distance d between the diffraction grating layer 112 and the AlGaInAs multiple quantum well active layer 103 subsequently formed satisfies expression (10). It should be noted that the distance d is equal to the difference between the film thickness of the n-InP cladding layer 113 (measured from the interface with the n-InP buffer layer 102) and that of the n-InGaAsP diffraction grating layer 112.
0 nm≦d≦200 nm (10)

As shown in FIG. 1, according to the present embodiment, the n-InGaAsP diffraction grating layer 112 formed in a stripe pattern is buried under the n-side InP cladding layer 113; the n-side InP cladding layer 113 fills the grooves in the n-InGaAsP diffraction grating layer 112. Our experiments show that the above arrangement can produce a buried structure having a more desirable shape, as compared to conventional arrangements in which a p-InGaAsP diffraction layer is buried under a p-InP cladding layer. It should be noted that the impurity added when the n-InP cladding layer 113 is formed is preferably sulfur (S) or silicon (Si). Forming a buried structure having such a desirable shape allows a highly reliable semiconductor laser to be produced.

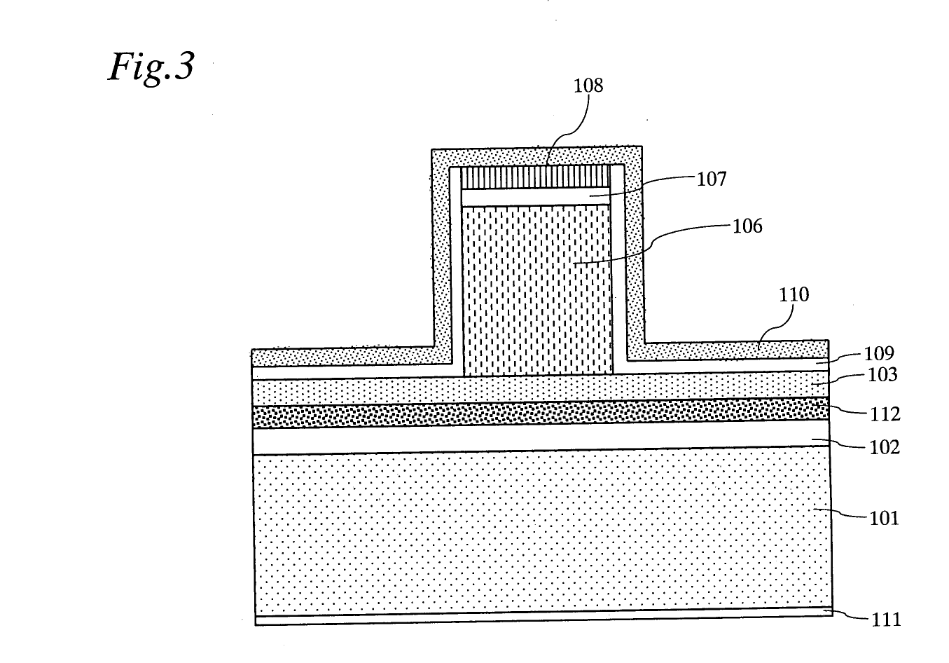

On the other hand, according to the present embodiment, the n-InP cladding layer 113 may be omitted, as shown in FIG. 3.

Referring to FIG. 1, the smaller the distance d, the larger the coupling constant κL. Therefore, the AlGaInAs multiple quantum well active layer 103 may be formed directly on the n-InGaAsP diffraction grating layer 112 so that the distance d is zero, as shown in FIG. 3. This arrangement can increase the coupling constant κL and thereby reduce the threshold current.

After forming the n-InP cladding layer 113, the AlGaInAs multiple quantum well active layer 103 is formed thereon by an MOCVD technique or MBE technique. It should be noted that the AlGaInAs multiple quantum well active layer 103 is an active layer including a multiple quantum well structure in accordance with the present invention. The film thickness of the AlGaInAs multiple quantum well active layer 103 may be set to approximately 400 nm, and the number of wells may be set to 4˜10.

Then, the p-InP cladding layer 106 is formed on the AlGaInAs multiple quantum well active layer 103 by an MOCVD technique or MBE technique. It should be noted that the p-InP cladding layer 106 is a p-type cladding layer of the present invention. The film thickness of the p-InP cladding layer 106 may be set to b 1,400 nm˜2,000 nm, and its carrier concentration may be set to 1×10¹⁸ cm⁻³˜2×10¹⁸ cm⁻³.

Then, the p-InGaAsP-BDR layer 107 is formed on the p-InP cladding layer 106 by an MOCVD technique or MBE technique. The film thickness of the p-InGaAsP-BDR layer 107 may be set to approximately 100 nm, and its carrier concentration may be set to 1×10¹⁸ cm⁻³˜5×10¹⁸ cm⁻³.

Then, the p-InGaAs contact layer 108 is formed on the p-InGaAsP-BDR layer 107 by an MOCVD technique or MBE technique. It should be noted that the p-InGaAs contact layer 108 is a p-type contact layer of the present invention. The film thickness of the p-InGaAs contact layer 108 may be set to 100 nm˜600 nm, and its carrier concentration may be set to approximately 1×10¹⁹ cm⁻³.

After that, the p-InGaAs contact layer 108, the p-InGaAsP-BDR layer 107, and the p-InP cladding layer 106 are wet-etched until the AlGaInAs multiple quantum well active layer 103 is reached, using, for example, an SiO₂ film as a mask. This forms a striped ridge portion 114 having a width of 1.6 μm˜2.5 μm.

Then, an SiO₂ insulating film 109 is formed on the entire surface, covering the ridge portion. Specifically, the SiO₂ insulating film 109 is formed to have a film thickness of 200 nm˜800 nm by a sputtering technique or CVD (Chemical Vapor Deposition) technique.

Then, the portion of the SiO₂ film on the p-InGaAs contact layer 108 is removed by selective etching, exposing the p-InGaAs contact layer 108 at the surface. After that, the Ti/Pt/Au anode electrode 110 is formed on the entire top surface of the n-InP substrate 101, and the AuGe/Ni/Ti/Pt/Ti/Pt/Au cathode electrode 111 is formed on the rear surface of the n-InP substrate 101. These electrodes may be laminated by a vapor deposition technique or sputtering technique. Further, the film thickness of each electrode may be set to 1 μm˜3 μm.

Thus, the above process can form a ridge type DFB semiconductor laser configured in accordance with the present embodiment.

The features and advantages of the present invention may be summarized as follows.

According to one aspect, a ridge type distributed feedback semiconductor laser of the present invention comprises: an n-type semiconductor substrate; an n-type diffraction grating layer formed above the semiconductor substrate; an active layer formed above the diffraction grating layer, the active layer including a multiple quantum well structure; and a ridge portion formed on the active layer, the ridge portion including a p-type cladding layer and a p-type contact layer. This arrangement can reduce the carrier recombination within the diffraction grating layer, making it possible to prevent a reduction in the laser light emission efficiency even when-the wavelength λg is increased to a value approximately equal to the oscillation wavelength λ.

Further, according to the present invention, since the wavelength λg and the oscillation wavelength λ satisfy the above expression (1), the coupling constant κL of the diffraction grating can be increased, allowing laser oscillation to occur at a low threshold current.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No.2003-404391, filed on Dec. 3, 2003 including specification, claims, drawings and summary, on which the Convention priority of the present application is based, are incorporated herein by reference in its entirely.

1. A distributed feedback semiconductor laser comprising:
an n-type semiconductor substrate;
an n-type diffraction grating layer above said semiconductor substrate;
an active layer above said diffraction grating layer, said active layer including a multiple quantum well structure; and
a ridge portion on said active layer, said ridge portion including a p-type cladding layer and a p-type contact layer, wherein a wavelength, λg, corresponding to bandgap energy of said diffraction grating layers and an oscillation wavelength, λ, of laser light produced by said semiconductor laser satisfy the relationship:
λ−150 nm<λg<λ+100 nm.

2. The distributed feedback semiconductor laser according to claim 1, wherein the wavelength λg and the oscillation wavelength λ satisfy the relationship:
λ−100 nm<λg<λ+100 nm.

3. The ridge type distributed feedback semiconductor laser according to claim 1, wherein the wavelength λg and the oscillation wavelength λ satisfy the relationship:
λ−50 nm<λg<λ+100 nm.

4. The ridge type distributed feedback semiconductor laser according to claim 1, wherein the wavelength λg and the oscillation wavelength λ satisfy the relationship:
λ−25 nm<λg<λ+100 nm.

5. The distributed feedback semiconductor laser according to claim 1, wherein the oscillation wavelength λ satisfies at least of one of the equations:
1.20 μm≦λ≦1.45 μm, and
1.45 μm≦λ≦1.65 μm.

6. The distributed feedback semiconductor laser according to claim 1, wherein a distance d from said diffraction grating layer to said active layer satisfies the equation:
0 nm≦d≦200 nm.

7. The distributed feedback semiconductor laser according to claim 6, wherein:
said diffraction grating layer is an n-InGaAsP layer; and
said active layer is an AlGaInAs layer.

8. The distributed feedback semiconductor laser according to claim 6, including an n-type cladding layer between said diffraction grating layer and said active layer.

9. The distributed feedback semiconductor laser according to claim 8, wherein:
said diffraction grating layer is an n-InGaAsP layer;
said active layer is an AlGaInAs layer; and
said n-type cladding layer is an n-InP layer containing either S or Si as an impurity.

10. The distributed feedback semiconductor laser according to claim 1, wherein a coupling constant κL of said diffraction grating layer satisfies the equation:
3≦κL≦5.

11. The distributed feedback semiconductor laser according to claim 1, wherein said semiconductor laser includes a resonator having a length L satisfying the equation:
200 μm≦L≦300 μm.
